(19) United States
(12) Patent Application Publication
(10) Pub. No.: US 2007/0201669 A1
(43) Pub. Date: Aug. 30, 2007

(54) Method and system for call control

(75) Inventor: Bingbing Yao, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: HUAWEI TECHNOLOGIES CO., LTD.

(21) Appl. No.: 11/723,090

(22) Filed: Mar. 16, 2007

Related U.S. Application Data
(63) Continuation of application No. PCT/CN05/02272, filed on Dec. 21, 2005.

(30) Foreign Application Priority Data
Dec. 21, 2004 (CN) 20041010603.7

(51) Int. Cl. H04M 7/00

(52) U.S. Cl. 379/221.09

(57) ABSTRACT

A method and system for call control, a Business Operation Supporting System (BOSS) and a Service Control Point (SCP) are disclosed. The method includes: upon receiving a call from a switch system, an SCP sends an authentication request with a subscriber identifier of the call to a BOSS; the SCP controls the call according to an authentication result upon receiving the authentication result of the BOSS authenticating a subscriber of the call according to the subscriber identifier of the call carried in the authentication request and subscriber information stored. The system includes the SCP and the BOSS. By using the invention, the benefits of the operators are protected.

### FIELD OF THE INVENTION

The present invention relates to the mobile communications technology, and more particularly, to a method and system for call control, and a Service Control Point (SCP), a Business Operation Supporting System (BOSS).

### BACKGROUND OF THE INVENTION

Along with the continuous development of the mobile communication technology, the communications between people become more and more rapid and convenient, and the number of mobile subscribers is increasing rapidly. For telecommunication developers and operators, how to determine the charging mode of various developed services has become an important issue of concern. These days, the pre-paid and post-paid charging modes are generally used in the developed mobile services.

For the post-paid mode, charging is performed based on a BOSS which is also called billing system. FIG. 1 shows a schematic diagram of charging in the post-paid mode and call control in accordance with the prior arts. As shown in FIG. 1, when the post-paid mode is adopted for charging, the post-paid subscriber may use a communication service before charging. Upon finishing a communication service, an exchange device such as a Mobile Switch Center (MSC)/Service Switch Point (SSP) may acquire the call duration, generate a call bill according to the call duration and send the call bill to the BOSS. The BOSS performs a charging process on the subscriber according to the received call bill.

In a post-paid service, as a subscriber can use the service before charging, such problems as excessive arrears and vicious arrears of a subscriber may emerge sometimes. To avoid the problems of excessive arrears and vicious arrears of a post-paid service subscriber, the solution to such problems in the prior arts is as shown in FIG. 1: The BOSS, according to the charging operations made by the BOSS itself on the subscriber, instructs a Home Location Register (HLR) to change the service attribute of the subscriber and stop the relevant voice service, data service and value-added service for the subscriber so as to implement the call control of the post-paid service subscriber, thereby avoid the problems of excessive arrears and vicious arrears by the subscriber.

However, in the prior arts, the BOSS can perform the charging process when a communication service is finished, and then stop the relevant services of the subscriber through the HLR according to the charging result. It is impossible, however, to timely control the call procedure of a subscriber through charging processing when a call is set up or during a call, and thus impossible to avoid the problems of excessive arrears and vicious arrears of the subscriber, thereby the benefits of the operators are harmed.

### SUMMARY OF THE INVENTION

Embodiments of the present invention provide a method and system for call control, and the embodiments of the present invention also provide a BOSS and an SCP to radically avoid problems of excessive arrears and vicious arrears of the subscribers.

The technical proposal of the embodiment of the present invention is implemented by the followings.

A method for call control includes the following processes: upon receiving a call from a switch system, an SCP sends an authentication request with a subscriber identifier of the call to a BOSS; the SCP controls the call according to an authentication result upon receiving the authentication result of the BOSS authenticating a subscriber of the call according to the subscriber identifier of the call carried in the authentication request and subscriber information stored.

A system for call control includes: an SCP which receives a call from a switch system and sends out an authentication request with a subscriber identifier of the call, receives an authentication result and controls the call according to the authentication result; a BOSS, which receives the authentication request from the SCP, authenticates a subscriber of the call according to a subscriber identifier of the call carried in the authentication request and subscriber information stored, and sends out the authentication result to the SCP.

An SCP includes a real-time call control unit which receives call information from a switch system, sends an authentication request carrying a subscriber identifier of a call to a BOSS, receives an authentication result sent by the BOSS and controls the call according to the authentication result.

A BOSS includes: a unit for receiving an authentication request carrying a subscriber identifier of a call sent by an SCP; a unit for storing the subscriber information; an authenticating and charging unit, performing an authentication on the call according to the subscriber identifier of the call carried in the authentication request and subscriber information stored; a unit for sending an authentication result to the SCP.

As seen from the above technical schemes, in a call procedure of a post-paid subscriber, it is possible to timely perform a charging evaluation on the subscriber according to a payment record of the subscriber and control the call according to the charging evaluation result. The method provided by an embodiment of the invention may radically avoid problems of excessive arrears and vicious arrears of the subscriber and protecting the benefits of the operators. In addition, according to the embodiment of the present invention, various information of pre-paid subscriber is pre-stored in a BOSS. Both the SCP and the BOSS are employed for charging evaluation and control. Therefore, the pre-paid subscribers can enjoy the care and services provided by the BOSS and thus the SCP needs not to perform the charging process, thereby the service load of the SCP may be decreased.

### BRIEF DESCRIPTION OF THE DRAWINGS

FIG. 1 is a schematic diagram illustrating charging in the post-paid mode and call control in accordance with the prior arts.

FIG. 2 is a schematic diagram of a basic structure of the system according to an embodiment of the present invention.

FIG. 3 is a schematic diagram of a preferred structure of the system according to an embodiment of the present invention.

FIG. 4 is a flowchart of an embodiment of the present invention.

FIG. 5 is a flowchart illustrating an authenticating and charging unit in the BOSS performing authentication and obtaining an authentication result according to an embodiment of the present invention.

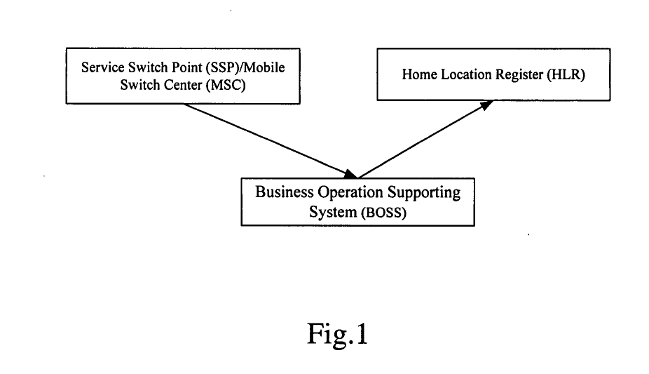

### DETAILED DESCRIPTION OF THE INVENTION

The embodiments of the present invention may be applied either to call control of a pre-paid subscriber or to call control of a post-paid subscriber. In case of the call control of a pre-paid subscriber, various information of the subscriber is added in the existing BOSS in advance in accordance with an embodiment of the present invention.

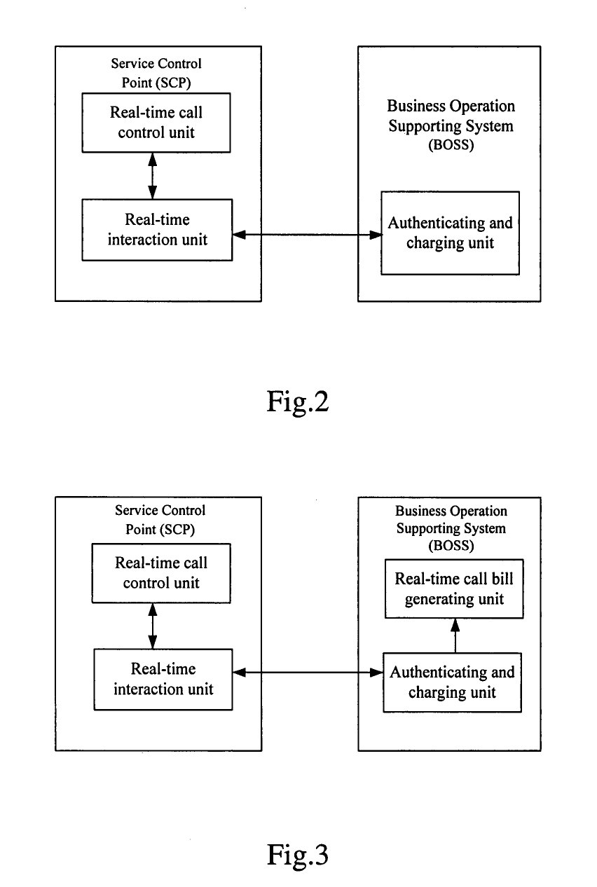

FIG. 2 shows the basic structure of a system for call control according to an embodiment of the present invention. As shown in FIG. 2, the embodiment of the present invention accordingly proposes a system. The system includes an SCP and a BOSS, in which the SCP further includes a real-time call control unit and a real-time interaction unit and the BOSS further includes an authenticating and charging unit.

The real-time interaction unit, on one hand, receives an authentication request carrying a subscriber identifier of a call sent by the real-time call control unit, and sends the authentication request carrying the subscriber identifier of the call to the authenticating and charging unit in the BOSS. On the other hand, the real-time interaction unit receives an authentication result sent by the authenticating and charging unit in the BOSS and sends the authentication result to the real-time call control unit in the SCP.

The real-time call control unit, on one hand, receives call information submitted by a switch system and sends the authentication request carrying the subscriber identifier of the call to the real-time interaction unit in the SCP. And the SSP or the MSC is an example of the switch system, in the following description the SSP or the MSC refers to the switch system. On the other hand, the real-time call control unit receives the authentication result sent by the real-time interaction unit and controls the call according to the authentication result.

The authenticating and charging unit receives the authentication request carrying the subscriber identifier of the call sent by the real-time interaction unit in the SCP, performs an authentication on this call according to the subscriber identifier of the call carried in the authentication request and the subscriber information stored in the authenticating and charging unit, and sends the authentication result to the real-time interaction unit in the SCP.

FIG. 3 shows a preferred structure of the system according to an embodiment of the present invention. As shown in FIG. 3, in order to timely indicate the service duration and charging information of the subscriber in a call, preferably, a real-time call bill generating unit may be further included in the BOSS. The authenticating and charging unit in the BOSS is further used for sending the service duration and the charging information in the call to the real-time call bill generating unit when the call is finished. The real-time call bill generating unit is used to create the call bill of the call timely when it receives the service duration and charging information in the call.

The present invention will be described in detail with reference to the accompanying drawings and embodiments.

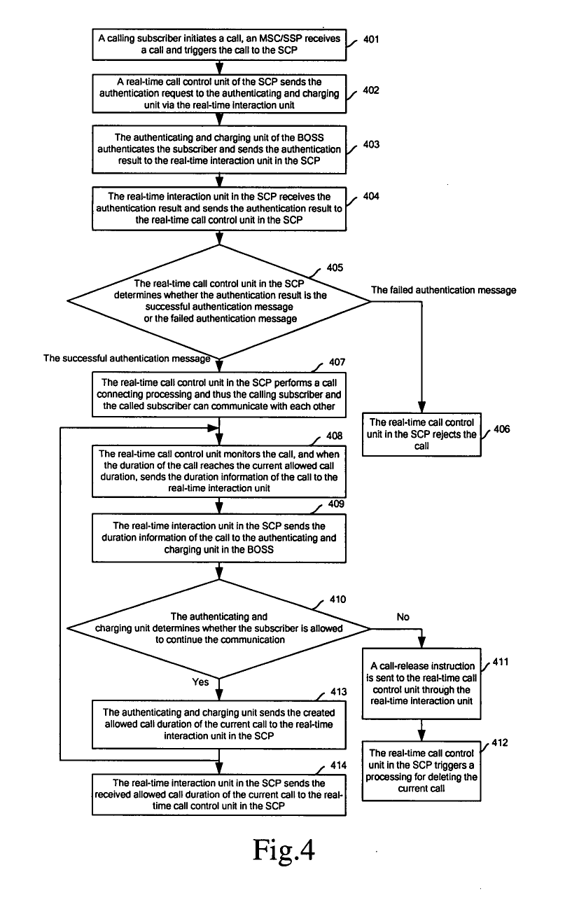

FIG. 4 shows a flowchart of an embodiment of the present invention. As shown in FIGS. 2 and 4, by using the system of the embodiment of the present invention, the method for call control in accordance with the embodiment of the present invention includes the following processes:

Step 401: a calling subscriber initiates a call. An MSC/SSP receives a call and triggers the call to an SCP.

In this process, upon receiving the call, the MSC/SSP directly triggers the call to the SCP regardless of whether the subscriber initiating the call is a pre-paid subscriber or a post-paid subscriber. In this way, it is ensured that the SCP may be used to perform a real-time call control on the call in the subsequent procedures either for a pre-paid subscriber or for a post-paid subscriber.

Step 402: a real-time call control unit of the SCP receives the call, carries subscriber information of the call in an authentication request and sends the authentication request to the real-time interaction unit of the SCP. The real-time interaction unit sends the received authentication request carrying the subscriber information of this call to an authenticating and charging unit of the BOSS.

The subscriber information of this call carried in the authentication request mentioned here and hereafter includes such information as the subscriber identifier of the call and etc.

In this process, after the call is triggered to the SCP, the SCP sends the authentication request to the BOSS so that the BOSS could perform a real-time charging evaluation on this call in the subsequent procedures.

Step 403: the authenticating and charging unit of the BOSS receives the authentication request carrying the subscriber information of this call, authenticates the subscriber according to the subscriber information of this call carried in the authentication request and the subscriber information stored in the authenticating and charging unit, and sends an authentication result to the real-time interaction unit in the SCP.

Here, for a post-paid subscriber, the BOSS stored the subscriber information for authentication in itself, such as the identifier, the balance information and the payment record information of the post-paid subscriber. For a pre-paid subscriber, according to the embodiment of the present invention, the pre-paid subscriber information such as the identifier, the balance information and the payment record information of the pre-paid subscriber are pre-stored in the BOSS. In this way, in this process, the BOSS can perform an authentication process either in the case of a post-paid subscriber or in the case of a pre-paid subscriber.

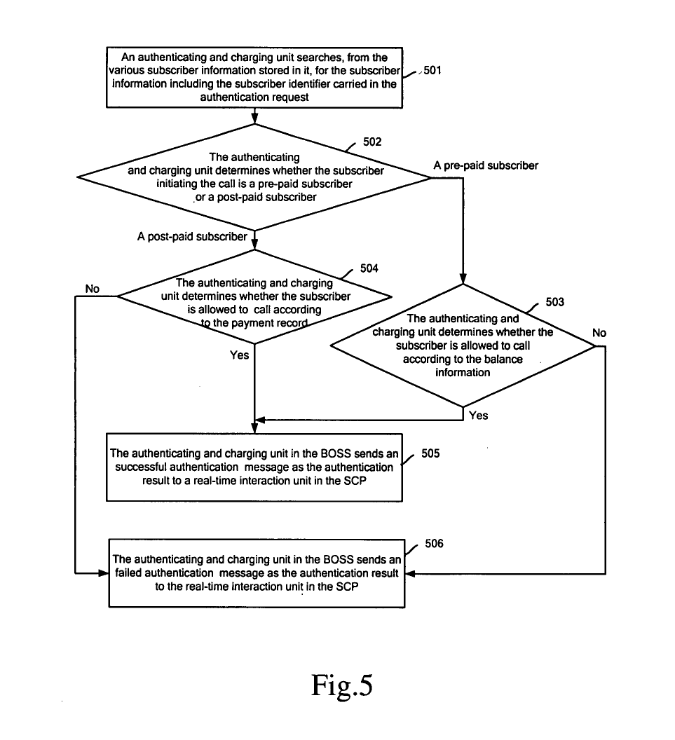

FIG. 5 shows a flowchart of performing an authentication and obtaining an authentication result by the authenticating and charging unit in the BOSS according to an embodiment of the invention. As shown in FIG. 5, the detailed implementation procedures of the above Step 403 include the following processes:

Step 501: an authenticating and charging unit in the BOSS searches, from the various subscriber information stored in the authenticating and charging unit, for subscriber information which includes the subscriber identifier carried in the authentication request.

Step 502: the authenticating and charging unit in the BOSS determines whether the subscriber initiating the call is a pre-paid subscriber or a post-paid subscriber according to the found subscriber information. If the subscriber is a pre-paid subscriber, proceed to Step 503. If the subscriber is a post-paid subscriber, proceed to Step 504.

Step 503: the authenticating and charging unit in the BOSS determines whether the subscriber initiating this call is allowed to call according to the balance information of this subscriber. If the subscriber is allowed to call, proceed to Step 505; otherwise, proceed to Step 506.

Step 504: the authenticating and charging unit in the BOSS determines whether the subscriber initiating the call is allowed to call according to a payment record of this subscriber. If the subscriber is allowed to call, proceed to Step 505; otherwise, proceed to Step 506.

Here, when the payment records of this subscriber indicate that this subscriber is able to pay the bill and/or has a few arrears, this subscriber is regarded to be allowed to call. If the payment records of this subscriber indicate that this subscriber has excessive arrears and/or is unable to pay the bill, this subscriber is regarded not to be allowed to call.

In the above Steps 503 and 504, both the balance information and the payment records of this subscriber are included in the subscriber information stored in the BOSS, thus the authenticating and charging unit in the BOSS can determine whether the subscriber initiating the call is allowed to call.

Step 505: the authenticating and charging unit in the BOSS sends a successful authentication message as the authentication result to a real-time interaction unit in the SCP and terminates the flow.

Step 506: the authenticating and charging unit in the BOSS sends a failed authentication message as the authentication result to the real-time interaction unit in the SCP.

By now, the process of performing the authentication procedure and generating the authentication result by the authenticating and charging unit in the BOSS is implemented.

It should be noted that, in the process shown in FIG. 5, when the authenticating and charging unit in the BOSS regards the successful authentication message as the authentication result, it generates the allowed call duration of the call for the subscriber according to the balance information (with respect to the pre-paid subscriber) or the payment records (with respect to the post-paid subscriber) of the subscriber, and carries the allowed call duration of the call in the successful authentication message sent to the real-time interaction unit in the SCP.

Step 404: the real-time interaction unit in the SCP receives the authentication result and sends the authentication result to the real-time call control unit in the SCP.

Step 405: the real-time call control unit in the SCP determines whether the authentication result is the successful authentication message or the failed authentication message. If the authentication result is the successful authentication message, proceed to Step 407. If the authentication result is the failed authentication message, proceed to Step 406.

Step 406: the real-time call control unit in the SCP rejects the call and terminates the procedure.

Step 407: the real-time call control unit in the SCP performs a call connecting processing and thus the calling subscriber and the called subscriber can communicate with each other.

By now, the process of controlling the setting up of the subscriber's call according to the balance information or the payment records by the BOSS and the SCP is implemented, and the problems of excessive arrears and vicious arrears of the subscriber may be avoided.

During the call, according to the embodiment of the present invention, the BOSS and the SCP may further control the course of the call by performing the subsequent procedures in FIG. 4 according to the balance information or the payment records and the call duration to prevent the problems of excessive arrears and vicious arrears of the subscribers.

During the communication between the calling subscriber and the called subscriber, the SSP/MSC periodically submits the call duration to the SCP.

Step 408: the real-time call control unit in the SCP timely monitors the call, and when the duration of the call has reached the allowed call duration of the call, sends the duration information of the call to the real-time interaction unit in the SCP.

Step 409: the real-time interaction unit in the SCP sends the duration information of the call to the authenticating and charging unit in the BOSS. The authenticating and charging unit in the BOSS receives the duration information of the call and calculates the fee corresponding to the call duration.

Step 410: the authenticating and charging unit in the BOSS determines whether the subscriber is allowed to continue the communication according to the calculated fee. If the subscriber is allowed to continue the communication, proceed to Step 413; otherwise, proceed to Step 411.

Here, if the subscriber of the call is a pre-paid subscriber, in this process, the authenticating and charging unit in the BOSS acquires the balance information of the current subscriber according to the calculated fee, and decides whether the current subscriber is allowed to continue the communications according to the balance of the current subscriber. If the subscriber of the call is a post-paid subscriber, in this process, the authenticating and charging unit in the BOSS decides whether the current subscriber is allowed to continue the communications according to the payment records and the calculated fee of the current subscriber i.e. the fee in this service.

Step 411: the authenticating and charging unit in the BOSS sends a call-release instruction to the real-time interaction unit in the SCP, and the real-time interaction unit sends the call-release instruction to the real-time call control unit in the SCP.

Step 412: the real-time call control unit in the SCP triggers a processing for deleting the current call. The BOSS, SCP as well as the SSP or the MSC perform the processing of releasing the current call, and the flow is terminated.

Step 413: the authenticating and charging unit in the BOSS generates an allowed call duration of the current call, and sends the allowed call duration of the current call to the real-time interaction unit in the SCP.

Here, if the subscriber of the call is a pre-paid subscriber, in this process, the authenticating and charging unit in the BOSS generates the allowed call duration of the current call according to the balance of the current subscriber. If the subscriber of this call is a post-paid subscriber, in this process, the authenticating and charging unit in the BOSS generates the allowed call duration of the current call according to the payment records of the subscriber and the calculated fee.

Step 414: the real-time interaction unit in the SCP sends the received allowed call duration of the current call to the real-time call control unit in the SCP, and Step 408 is repeated.

It should be noted that, when the real-time call control unit in the SCP timely monitors the call, if it receives a call-release request sent by the current subscriber through the SSP/MSC, it sends the call-release request carrying the duration of the call to the real-time interaction unit in the SCP. The real-time interaction unit in the SCP then sends the call-release request carrying the duration of the call to the BOSS. In this way, the BOSS, the SCP, and the SSP or the MSC perform the process of releasing the current call. In addition, as shown in FIG. 3, upon performing the process of releasing the current call by the BOSS, the authenticating and charging unit in the BOSS sends the duration information and the charging information in this call to the real-time call bill generating unit in the BOSS. The real-time call bill generating unit timely creates a call bill for the call when it receives the duration information and the charging information in the call sent by the authenticating and charging unit.

In the embodiment of the present invention, the subscriber of the call may be a calling subscriber and/or a called subscriber.

In view of the above, an interface for timely interacting various information is added between the real-time interaction unit in the SCP and the authenticating and charging unit in the BOSS. The Transmission Control Protocol (TCP)/Internet Protocol (IP) may be used as the bottom layer communication protocols of the interface. Moreover, the application protocols of the interface for timely interacting various information between the real-time interaction unit and the authenticating and charging unit may adopt the existing protocols or the user-defined protocols. When an existing protocol is used, the application protocol may be exemplified by a Unified Accounting Service Protocol (UASP), and the concrete implementation may be exemplified by the following: redefining an UASP interface, wherein the message format supported by the redefined UASP interface may be defined according to the message format of the existing UASP interface, such as A interface or C interface etc., or adding various messages relevant to the embodiment of the present invention in the existing UASP interface such as T interface.

The foregoing is preferred embodiments of this invention, and is not intended to limit the present invention. The invention is to cover all the modifications, variations and equivalent replacements within the spirit and scope of the disclosure as defined by the appended claims.

What is claimed is:

1. A method for call control, comprising:
upon receiving a call from a switch system, sending, by a Service Control Point (SCP), an authentication request with a subscriber identifier of the call to a Business Operation Supporting System (BOSS);
controlling, by the SCP, the call according to an authentication result upon receiving the authentication result of the BOSS authenticating a subscriber of the call according to the subscriber identifier of the call carried in the authentication request and subscriber information stored.

2. The method of claim 1, wherein the process of controlling by the SCP the call according to the authentication result upon receiving the authentication result of the BOSS authenticating a subscriber of the call according to the subscriber identifier of the call carried in the authentication request and subscriber information stored comprises:
searching, by the BOSS, for the subscriber information according to the subscriber identifier, and determining whether a subscriber is allowed to proceed to the call according to the subscriber information;
if the subscriber is allowed to proceed to the call, sending by the BOSS a successful authentication message as a first authentication result to the SCP, performing by the SCP a call connecting processing upon receiving the first authentication result;
if the subscriber is not allowed to proceed to the call, sending by the BOSS a failed authentication message as a second authentication result to the SCP, and rejecting by the SCP the call upon receiving the second authentication result.

3. The method of claim 2, wherein:
the subscriber is a post-paid subscriber;
the process of determining by the BOSS whether a subscriber is allowed to proceed to the call according to the subscriber information comprises:
determining, by the BOSS, whether the subscriber is allowed to proceed to the call according to a payment record of the subscriber in the subscriber information.

4. The method of claim 2, wherein:
the subscriber is a pre-paid subscriber;
the method further comprises:
storing information of pre-paid subscribers including the subscriber identifier and balance of the subscribers in the BOSS;
the process of determining by the BOSS whether the subscriber is allowed to proceed to the call according to the subscriber information comprises:
determining, by the BOSS, whether the subscriber is allowed to proceed to the call according to the balance in the subscriber information.

5. The method of claim 2, further comprising:
before the BOSS sending the first authentication result to the SCP, generating by the BOSS an allowed call duration according to the subscriber information, and carrying the allowed call duration in the first authentication result.

6. The method of claim 5, further comprising:
sending, by the SCP, the duration of the call to the BOSS upon monitoring that a duration of the call reaches the allowed call duration;
calculating, by the BOSS, a fee according to the duration of the call;
determining, by the BOSS, whether the subscriber is allowed to continue the call according to the fee;
if the subscriber is allowed to continue the call, generating by the BOSS a currently allowed call duration and sending the currently allowed call duration to the SCP, and monitoring the duration of the call by the SCP;
if the subscriber is not allowed to continue communications, sending by the BOSS a call-release instruction to the SCP, sending the call-release instruction to the switch system by the SCP, and releasing the call.

7. The method of claim 6, wherein:
the subscriber is a post-paid subscriber;
the process of determining by the BOSS whether the subscriber is allowed to continue the call according to the fee comprises:
determining, by the BOSS, whether the subscriber is allowed to continue the call according to the payment record of the subscriber and the fee.

8. The method of claim 6, wherein:
the subscriber is a pre-paid subscriber;
the process of determining by the BOSS whether the subscriber is allowed to continue the call according to the fee comprises:
acquiring, by the BOSS, the balance of the subscriber according to the fee, and determining whether the subscriber is allowed to continue the call according to the balance of the subscriber.

9. The method of claim 6, further comprising:
when releasing the call, generating by the BOSS a bill of the call according to duration information and charging information in the call.

10. The method of claim 1, wherein a bottom layer communication protocol for interaction between the SCP and the BOSS is Transmission Control Protocol (TCP)/Internet Protocol (IP).

11. The method of claim 1, wherein an application layer protocol for interaction between the SCP and the BOSS is a user-defined protocol or an existing application protocol.

12. A system for call control, comprising:
a Service Control Point (SCP), receiving a call from a switch system and sending out an authentication request with a subscriber identifier of the call, receiving an authentication result and controlling the call according to the authentication result;
a Business Operation Supporting System (BOSS), receiving the authentication request from the SCP, authenticating a subscriber of the call according to a subscriber identifier of the call carried in the authentication request and subscriber information stored, and sending out the authentication result to the SCP.

13. The system of claim 12, further comprising:
a real-time call bill generating apparatus, creating a call bill of the call when the real-time call bill generating apparatus receives call duration information and charging information in the call from the BOSS;
wherein the BOSS is further configured to send call duration information and charging information to the real-time call bill generating apparatus when releasing the call.

14. The system of claim 13, wherein the real-time call bill generating apparatus is located in the BOSS.

15. A Service Control Point (SCP), comprising:
a real-time call control unit, receiving call information from a switch system, sending an authentication request carrying a subscriber identifier of a call to a Business Operation Supporting System (BOSS), receiving an authentication result sent by the BOSS and controlling the call according to the authentication result.

16. The SCP of claim 15, further comprising:
a real-time interaction unit, forwarding the authentication request and the authentication result between the BOSS and the real-time call control unit.

17. A Business Operation Supporting System (BOSS), comprising:
a unit for receiving an authentication request carrying a subscriber identifier of a call sent by a Service Control Point (SCP);
a unit for storing the subscriber information;
an authenticating and charging unit, performing an authentication on the call according to the subscriber identifier of the call carried in the authentication request and subscriber information stored; and
a unit for sending an authentication result to the SCP.

18. The BOSS of claim 17, further comprising:
a real-time call bill generating unit, creating a call bill of the call when the real-time call bill generating unit receives call duration information and charging information in the call from the authenticating and charging unit;
wherein the authenticating and charging unit is further configured to send the call duration information and charging information to the real-time call bill generating unit when releasing the call.
